(19) United States
(12) Patent Application Publication
(10) Pub. No.: US 2014/0053424 A1
(43) Pub. Date: Feb. 27, 2014

(54) Dryer Having a Direct Drive Fan

(71) Applicants: Justin M. Schreiber, Raleigh, NC (US); Steve Blackowiak, Clayton, NC (US)

(72) Inventors: Justin M. Schreiber, Raleigh, NC (US); Steve Blackowiak, Clayton, NC (US)

(73) Assignee: Buhler Aeroglide Corporation, Cary, NC (US)

(21) Appl. No.: 13/972,404

(22) Filed: Aug. 21, 2013

Related U.S. Application Data
(60) Provisional application No. 61/692,881, filed on Aug. 24, 2012.

(51) Int. Cl. A23L 3/40

(52) U.S. Cl. CPC A23L 3/40
USPC 34/218

(57) ABSTRACT

A dryer is provided with a direct drive fan assembly for circulating air through a drying chamber formed in the dryer. The direct drive fan assembly includes a fan plug mounted to the dryer and a fan rotatively mounted adjacent an interior side of the fan plug. A load adapter is secured to the fan plug and projects outwardly therefrom. A motor is mounted to the load adapter via a motor adapter. There is provided a continuous drive shaft assembly from the motor, through the motor adapter, through the load adapter, and through the fan plug. The drive assembly connects to the fan disposed adjacent the interior side of the fan plug.

This application claims priority under 35 U.S.C. §119(e) from the following U.S. provisional application: Application Ser. No. 61/692881 filed on Aug. 24, 2012. That application is incorporated in its entirety by reference herein.

### FIELD OF THE INVENTION

The present invention relates to hygienic dryers for drying foodstuffs and related products.

### BACKGROUND

Dryers are used for removing moisture from various materials, including foodstuffs. Such dryers typically include means for providing heated air to the material to be dried. These means typically include fans or blowers that are driven by electric motors. Generally, the electric motor is supported on a framework and a motor output shaft of the motor is coupled to fan input shaft using a belt drive power transmission system.

Drying systems used for drying foodstuffs for human consumption are typically required to meet rigorous hygienic requirements. Meeting such requirements includes a wide array of considerations, such as cleanliness in the operation of electrical and mechanical components and simplicity and ease of maintenance of such components.

There is a need to develop a drive system for dryer fans that meets the rigorous hygienic requirements imposed on drying systems, especially those used to dry food products consumed by humans. In particular, there is a need to develop a direct drive system for dryer fans that reduces the potential for wear particles to be emitted, and at the same time is energy efficient and easy to service and maintain.

### SUMMARY OF THE INVENTION

A conveyor dryer for drying or conditioning foodstuff is disclosed. The dryer comprises a housing structure, a drying chamber, a burner unit for heating air, and a fan disposed within the housing structure for circulating heating or conditioning air through the drying chamber. A direct drive assembly is provided for driving the fan. The direct drive assembly, in one embodiment, includes a fan plug or panel that is secured to the dryer housing structure adjacent the fan. An electric motor having an output shaft is operatively connected to a load adapter via a drive coupling. The load adapter is secured to the fan plug and includes an output shaft that extends through the fan plug and is operatively connected to the fan for driving the fan. A motor mount or adapter is operatively interconnected between the motor and the load adapter. Thus the motor, load adapter, drive coupling and motor mount is supported in cantilever fashion by the fan plug.

In one embodiment, the motor mount operatively connected between the electric motor and the load adapter comprises a housing or enclosure that generally encloses the drive coupling connected between the output shaft of the motor and the load adapter.

In one particular embodiment, the present invention comprises a dryer for drying product. The dryer includes a housing, a drying chamber formed in the housing of the dryer, a burner unit for heating air used to dry the product, and a direct drive fan assembly for circulating air through the drying chamber. The direct drive fan assembly includes a fan plug mounted to the dryer and a fan rotatively mounted adjacent an interior side of the fan plug. A load adapter is mounted to the fan plug and is supported by the fan plug. The load adapter projects outwardly from an exterior side of the fan plug. The load adapter includes a drive shaft or drive assembly extending through the fan plug and operatively connected to the fan for driving the fan. A motor adapter or motor mount is mounted or secured to the load adapter and projects therefrom. A motor is mounted to the motor adapter such that the motor adapter is disposed generally between the motor and the load adapter. The motor includes an output shaft that projects through at least a portion of the motor adapter and is operatively connected to the drive shaft of the load adapter such that torque generated by the motor is transferred to the drive shaft of the load adapter, which in turn is operative to drive the fan.

The dryer disclosed herein can also be described as including a dryer housing and a drying chamber formed in the dryer. A burner unit is provided for heating air to dry a product. A direct drive fan assembly is provided for circulating air through the drying chamber. The direct drive fan assembly comprises a fan plug mounted to the dryer, a fan mounted on the interior side of the fan plug, a load adapter secured to the fan plug and projected outwardly therefrom on the opposite side of the fan plug from the fan, the load adapter having a housing, a motor mount or motor adapter secured to the load adapter opposite the fan plug, the motor adapter including a housing having an open area therein, and a motor mounted to the motor adapter opposite the load adapter and including an output shaft. There is provided means extending through the housing of the motor adapter, through the housing of the load adapter and through the fan plug and operatively connected to the fan for transferring driving torque from the output shaft of the motor to the fan for driving the fan.

Other objects and advantages of the present invention will become apparent and obvious from a study of the following description and the accompanying drawings which are merely illustrative of such invention

### BRIEF DESCRIPTION OF THE DRAWINGS

FIG. 1 is a cross-sectional view of a conventional dryer having the direct drive fan assembly incorporated therein.

FIG. 2 is a perspective view of the direct drive fan assembly.

FIG. 3 is a vertical cross-sectional view of the direct drive fan assembly.

FIG. 4 is a fragmentary cross-sectional view of a portion of the direct drive fan assembly illustrating the connection between the load adapter and the fan.

FIG. 5 is a fragmentary cross-sectional view of a portion of the direct drive fan assembly illustrating the drive coupling.

FIG. 6 is a perspective view of a fan plug or panel (with face plate removed) that serves as an interface between the fan and load adapter.

FIG. 7 is an exterior side elevational view of the fan plug.

FIG. 8 is a horizontal cross-sectional view of the fan plug taken through line VIII-VIII of FIG. 7.

FIG. 9 is a fragmentary cross-sectional view of the fan plug, taken through line IX-IX of FIG. 7 illustrating a check valve incorporated therein.

FIG. 10 is a perspective view of the motor adapter which functions to connect the electric motor to the load adapter

### DETAILED DESCRIPTION OF THE INVENTION

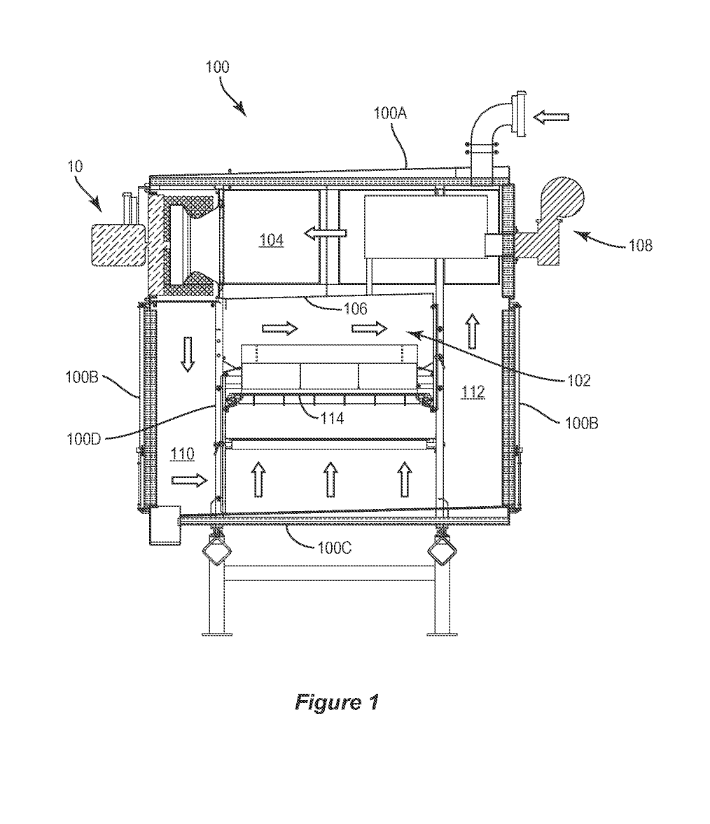

With further reference to the drawings, the dryer of the present invention is shown therein and indicated generally by the numeral 100. Dryer 100 is a commercial or industrial dryer that is utilized to dry a wide variety of products, particularly food products such as cereal, grains, fruits and vegetables as well as animal feed. Details of the dryer are not dealt with herein because such is not per se material to the present invention and because dryers of the type shown in FIG. 1 and discussed herein are well known and appreciated by those skilled in the art.

A brief description of the dryer 100 is in order. Dryer 100, in this example, is a conveyor dryer and basically comprises a housing structure that includes a top 100A, opposed sides 100B, a bottom 100C and a support structure 100D. In addition, the dryer 100 includes opposed ends (not shown).

Formed internally within the dryer 100 is a drying or conditioning chamber indicated generally by the numeral 102. Drying or conditioning chamber 102 is formed or surrounded by an intermediate upper wall 106 that, together with the top 100A of the dryer, forms an upper plenum 104.

Dryer 100 also includes a system for generating and circulating a system of heated or conditioned air. In this regard, disposed about an upper side portion of the drying structure is a burner unit indicated generally by the numeral 108. Disposed opposite the burner unit 108 is a direct dry fan assembly indicated generally by the numeral 10. As illustrated in FIG. 1, the burner unit 108 generates heat and a system of air that is pulled or moved across the burner unit through the upper plenum 104. This system of air is directed downwardly through side plenum 110 by the direct drive fan assembly 10. The system of air, in this example, is directed from the side plenum 110 into a lower portion of the drying chamber 102. Once the system of heated or conditioned air moves into the drying chamber 102, the air moves generally upwardly through a conveyor 114 which, in one example, supports and transports foodstuff through the drying chamber. Typically the heated air in the drying chamber 102 moves therefrom to another side plenum 112 where the heated air continues to move upwardly past the burner unit 108. This recirculation pattern is continued while the conveyor and the material thereon move from one end of the dryer 100 to the other end.

Drying chamber 102, in some embodiments, is designed to include a number of interchangeable panels that permit airflow to be directed in various directions through the drying chamber 102. Thus, the air pattern through the drying chamber 102 can be varied or reversed by simply rearranging panels within the dryer. For example, instead of the air moving upwardly through the conveyor 114, by selectively rearranging interchangeable panels within the dryer, the air can be directed into the drying chamber 102 above the conveyor 114 and then downwardly through the conveyor and the material thereon and out a side opening underneath the conveyor after which the air is recirculated back past the burner unit 108.

For a more complete and unified understanding of the basic structure and operation of conventional dryers, one is referred to dryers manufactured and sold by Buhler Aeroglide Corporation, headquartered in Cary, N.C., USA.

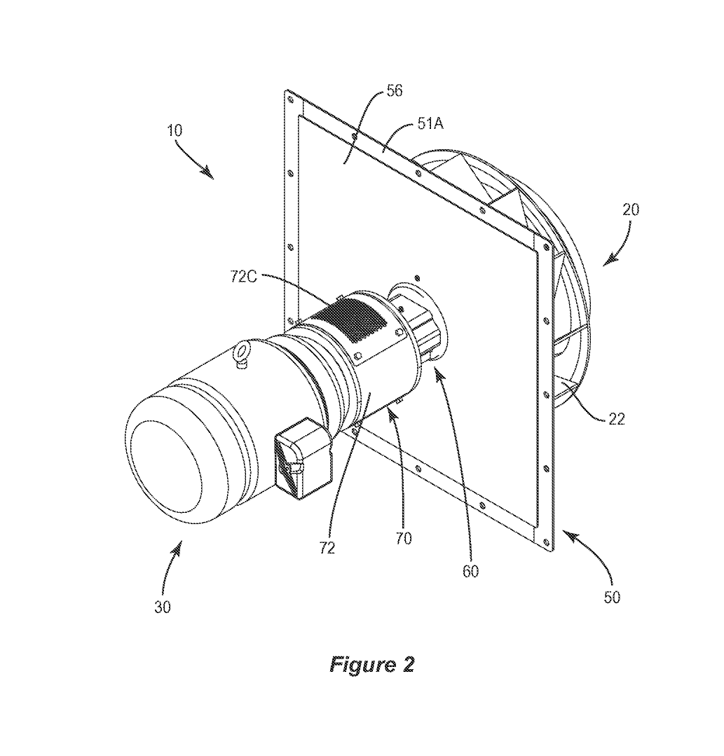

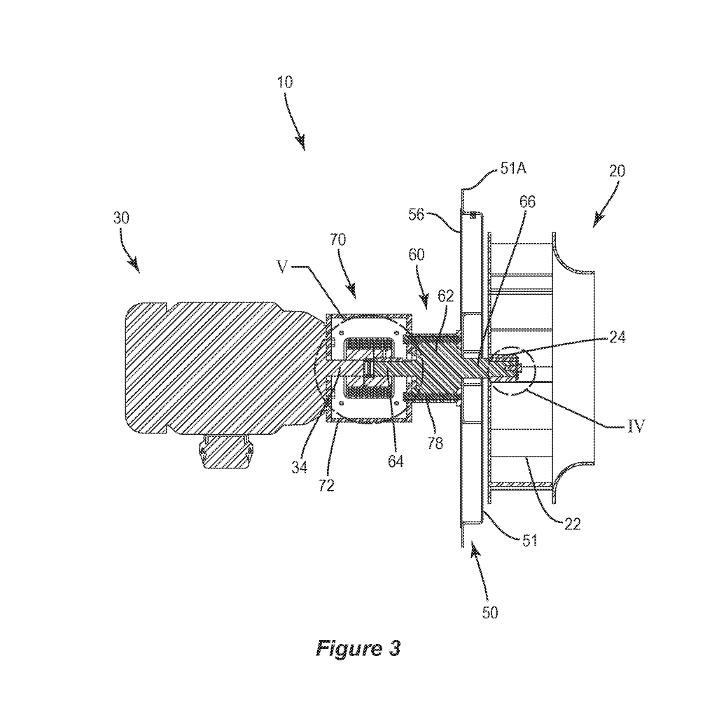

With reference particularly to FIGS. 2 and 3, the direct drive fan assembly 10 includes a fan 20 for moving heated air, a motor 30 for driving the fan, and a connecting and mounting sub-assembly for mounting the motor on dryer 100 and for operatively connecting the motor to the fan. This sub-assembly includes a fan plug or panel 50 detachably secured to dryer 100, an overhung load adapter 60 mounted to the fan plug, and a motor adapter 70 mounted to the load adapter for receiving and supporting motor 30. It is appreciated that when fan plug 50 is secured to dryer 100, motor 30, motor adapter 70 and load adapter 60 are together supported in a cantilever fashion by the fan plug 50.

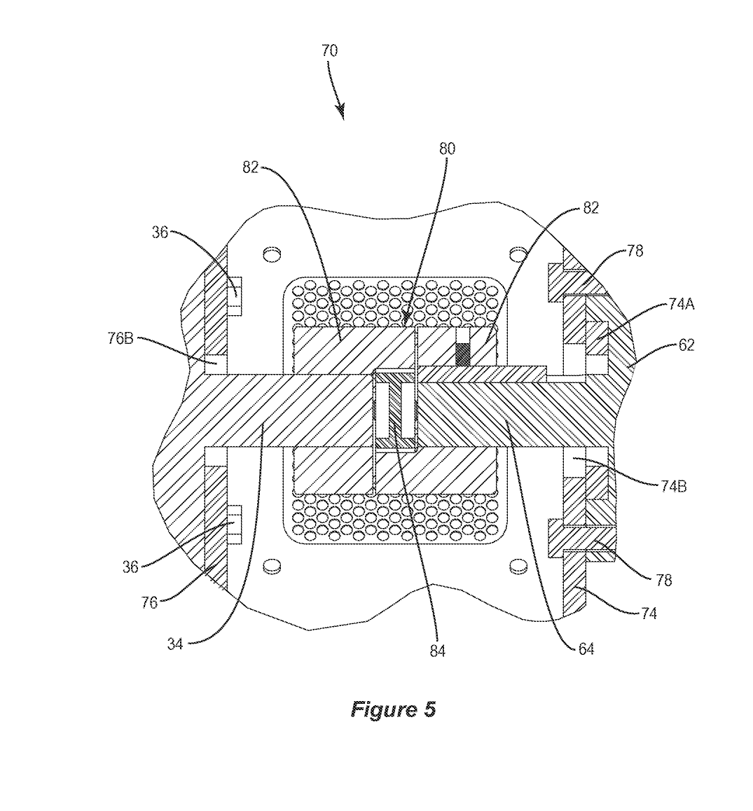

Considering power transmission from motor 30 to fan 20, a motor output shaft 34 and an input shaft 64 of load adapter 60 are mechanically connected by a drive coupling 80 that is enclosed within motor adapter 70 as shown in FIGS. 3 and 5. An output shaft 66 of load adapter 60 protrudes through fan plug 50 and has mounted thereto a fan wheel 22 forming a part of the fan 20. A drive line is thus formed through which rotary power from the motor 30 turns fan wheel 22 to operate fan 20. A more detailed description of the above-introduced components of the direct drive fan assembly 10 and the interconnection of the components is provided below.

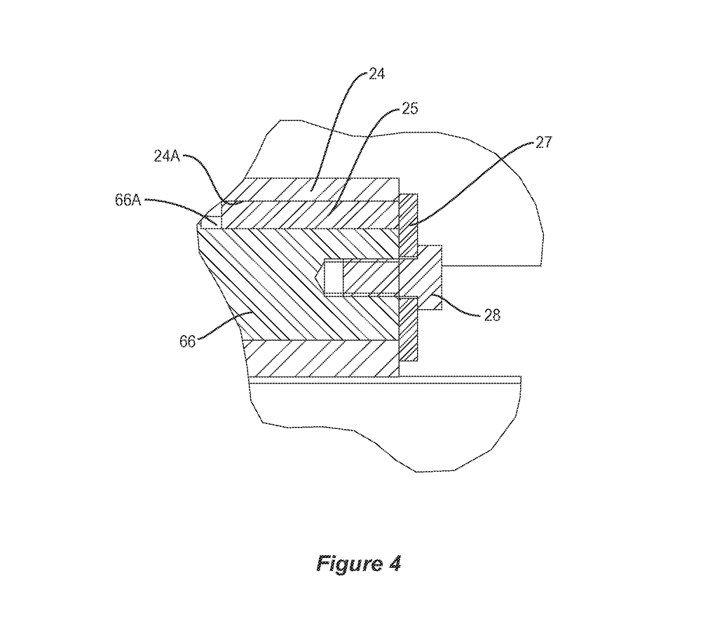

Fan 20 comprises the fan wheel 22 which includes a hub 24 secured to output shaft 66 of load adapter 60 as shown in FIGS. 3 and 4. More particularly, hub 24 is secured to shaft 66 by a key 25 engaging a keyway 66A and a mating hub keyway 24A. Key 25 is retained in place by retainer washer 27, which, in turn, is secured to shaft 66 by screw 28 that is threadedly-engaged with the shaft as illustrated in FIG. 4.

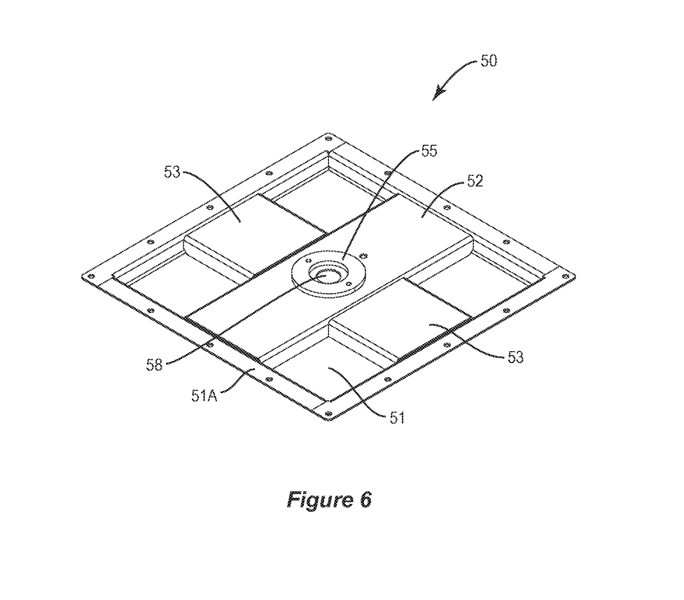

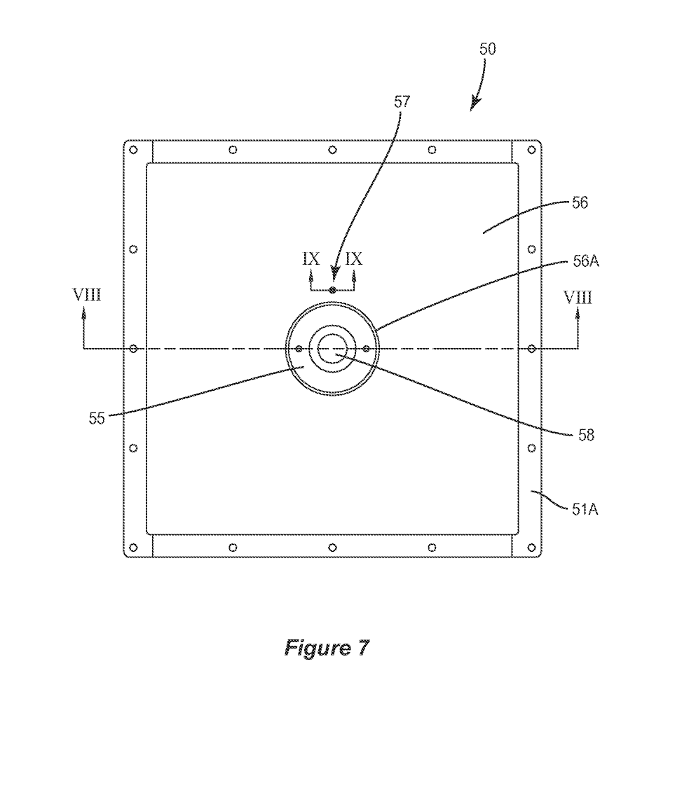

Fan plug 50 is particularly shown in FIGS. 6-9. Fan plug 50 forms a detachable panel secured over an opening in the dryer housing. In one embodiment, fan plug 50 comprises a rectangular panel weldment fabricated of stainless steel and includes a pan or back 51, a vertical support rib 52, a pair of horizontal support ribs 53, a pipe stub 54, a load adapter mounting plate 55, a face plate 56 (FIGS. 2, 3 and 7), and a press fitted check valve 57. Pan 51 includes an outwardly-facing cavity, and a lip structure that forms a surrounding perimeter 51A. Perimeter 51A includes a series of spaced apart mounting openings.

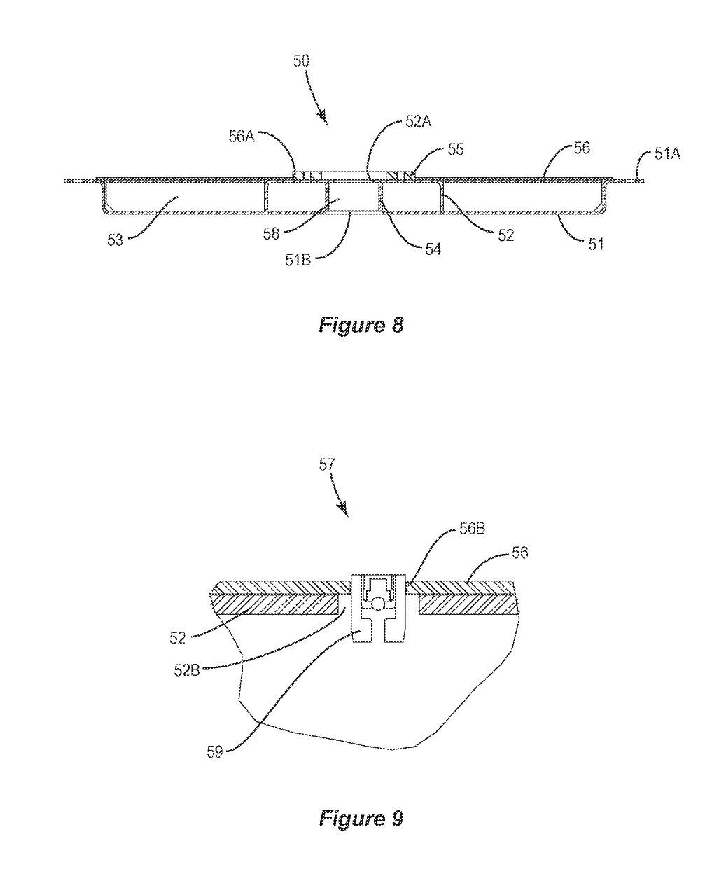

Vertical support rib 52 comprises an elongated channel and is disposed generally within a cavity formed between the pan 51 and face plate 56 with the concave aspect of the channel facing the pan 51. Rib 52 extends between upper and lower lips and lies generally parallel with and is generally centered between the side lips. Vertical support rib 52 also includes a rib opening 52A (FIG. 8) and a first vent opening 52B (FIG. 9). Rib opening 52A is aligned with pan opening 51B (FIG. 8). Each of the horizontal support ribs 53 comprise channel members similar to vertical rib 52 but generally having a shorter length than that of the vertical rib. Ribs 53 are disposed in the pan cavity and extend from a side of vertical support rib 52 to a portion of the perimeter 51A. Pipe stub 54 extends from pan opening 51B through rib opening 52A forming a bushed opening 58 through fan plug 50 (FIG. 8). Insulation (not shown) is typically included within the cavity of the fan plug 50.

Load adapter mounting plate 55 in one embodiment comprises a generally annular ring having a pair of threaded openings (FIGS. 6, 7 and 8). Mounting plate 55 is disposed on vertical support rib 52. Mounting plate 55 also projects through an opening formed in the face plate 56. See FIG. 8 for example.

Face plate 56 comprises a thin, generally flat panel having an opening 56A for receiving mounting plate 55 and a vent opening 56B. Plate 56 is disposed against the outer face of ribs 52 and 53 such that the plate extends onto the lips or perimeter 51A (FIG. 3). As noted above, the face plate 56 includes a central opening 56A that aligns with the opening 52A formed in rib 52. In addition, face plate 56 includes another opening 56B (FIG. 9) that aligns with the vent opening 52B formed in the rib 52.

Check valve 57 comprises a pressure relief valve for venting the sealed cavity formed between the face plate 56 and the back portion of the pan 51 See FIG. 9 for example. Check valve 57 is press fit into bung 59 which is welded into vent opening 56B, which is in face plate 56, such that an upstream port of the check valve is inwardly directed towards the interior cavity and a downstream port is outwardly directed away from face plate 56.

Considering now load adapter 60, the adapter forms a power transmission component that resists bending of a driveline due to overhung loads such as those due to the weight of motor 30 and the other components of the sub-assembly. Adapter 60 generally comprises an adapter body 62 and through shafting, opposite end portions of which form the adapter input shaft 64 and the adapter output shaft 66. In one embodiment, the adapter input shaft 64 and the adapter output shaft 66 are integral and form a single shaft rotatably mounted in bearings. One example of the load adapter is the OHLA Special from Zero-Max, Inc. 13200 Sixth Avenue North, Plymouth, Minn. 55441.

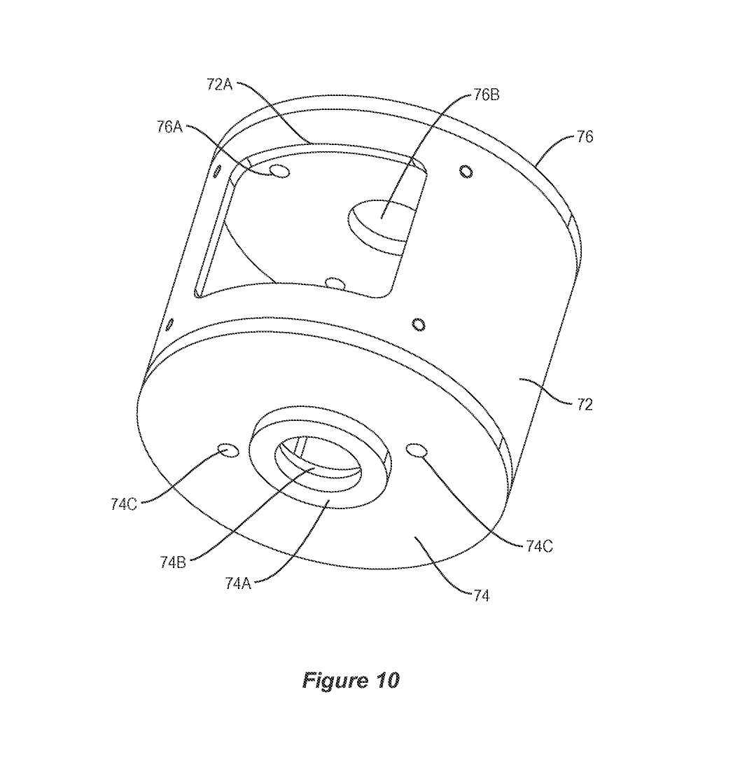

Turning now to motor adapter 70 and referring particularly to FIGS. 2, 3 and 10, the motor adapter comprises a generally tubular wall 72 with a load adapter mount plate 74 secured to one end of the tubular wall and a motor mount plate 76 secured to an opposite end of the tubular wall. See FIG. 10. In one embodiment, adapter 70 is formed as a weldment configured from stainless steel. Tubular wall 72 includes an access opening 72A over which may be secured an access cover 72C. Load adapter mounting plate 74 includes an abutment embossment or ring 74A encircling a shaft opening 74B. A pair of securement holes 74C on mounting plate 74 enables the load adapter to be secured to the motor adapter 70. Motor mounting plate 76 includes a shaft opening 76B and a series of securement holes arrayed around the shaft opening. As seen in FIG. 5, the motor mounting plate 76 can be secured to the motor 30 by four bolts 36. It is appreciated that the series of holes 74C includes holes that align with the threaded openings in the mounting plate 55 of the fan plug 50. As seen in FIGS. 3 and 5, elongated bolts 78 couple the motor adapter 70 to both the load adapter 60 and the fan plug 50.

The drive coupling 80 forms the power transmission connection between motor output shaft 34 and load adapter 60 and is mechanically secured to both shafts 34 and 64 as shown in FIGS. 3 and 5. Coupling 80 includes a pair of jaws 82 that mutually engage a resilient spider 84. One of the jaws 82 is secured to motor output shaft 34 and the other jaw is secured to the load adapter input shaft 64. Shafts 34 and 64 are connected to the jaws 82 through conventional keyway attachments. Jaws 82 generally do not contact each other. Rather, power is transferred between jaws 82 through resilient spider 84. In one embodiment, drive coupling 80 is an L-Type Jaw Coupling available from Lovejoy, Inc. 2655 Wisconsin Avenue, Downers Grove, Ill. 60515.

As appreciated from the foregoing discussion, power produced by the motor 30 is directed to the motor output shaft 34. Coupling 80 interconnects the motor output shaft 34 with the load adapter input shaft 64. Consequently, torque generated by the motor output shaft 34 is transferred to the adapter input shaft 64. The coupling assembly 80 is enclosed by the motor mount or adapter 70 which structurally connects the motor 30 to the load adapter 60. Thereafter, it is appreciated that torque transfer to the load adapter input shaft 64 is directed to the hub 24 of the fan 20. As discussed above, the fan plug 50 is structurally designed to support the entire direct fan drive assembly 10. See FIG. 3. The motor 30, motor adapter 70 and load adapter 60 are supported directly and solely in cantilever fashion by the fan plug 50.

Therefore it is appreciated that the direct drive fan assembly 10 as depicted in FIG. 2 overcomes numerous disadvantages commonly associated with indirect fan drive systems for dryers. By providing a compact and simple direct drive system for driving the fan, there is less opportunity for wear particles to be emitted from the drive system. Moreover, the direct drive fan assembly of the present invention is energy efficient and easy to service and maintain.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A dryer for drying a product, comprising:
a housing;
a drying chamber formed in the housing of the dryer;
a burner unit for heating air used to dry the product;
a direct drive fan assembly for circulating air through the drying chamber, the direct drive fan assembly comprising:
(i) a fan plug mounted to the dryer;
(ii) a fan rotatively mounted adjacent an interior side of the fan plug;
(iii) a load adapter mounted to the fan plug and supported by the fan plug and projecting outwardly from an exterior side of the fan plug;
(iv) the load adapter including a drive shaft extending through the fan plug and operatively connected to the fan for driving the fan;
(v) a motor adapter mounted to the load adapter and projecting therefrom;
(vi) a motor mounted to the motor adapter such that the motor adapter is disposed generally between the motor and the load adapter; and
(v) the motor including an output shaft that projects through at least a portion of the motor adapter and is operatively connected to the drive shaft of the load adapter such that torque generated by the motor is transferred to the drive shaft of the load adapter, which in turn is operative to drive the fan.

2. The dryer of claim 1 wherein the fan plug includes a panel detachably mounted to the dryer and wherein the fan plug supports the load adapter, motor adapter and motor in cantilever fashion.

3. The dryer of claim 2 wherein the fan plug includes at least one rib and a load adapter mounting plate disposed on the rib for connecting to the load adapter.

4. The dryer of claim 1 wherein the fan plug includes a fabricated panel that is detachably mounted to the dryer and wherein the fabricated panel includes: a face plate that faces the motor; at least one rib formed interiorly of the face plate; a load adapter mounting structure formed on the rib for interfacing with the load adapter; and a shaft opening aligned with the load adapter mounting structure and extending through the fabricated panel.

5. The dryer of claim 4 wherein the fabricated panel that forms the fan plug includes a back spaced from the face plate and wherein there is an open area defined between the face plate and back.

6. The dryer of claim 1 wherein the motor adapter includes a housing having an open area therein, and wherein the output shaft of the motor projects into the open area of the motor adapter; wherein the drive shaft of the load adapter includes an input shaft that projects into the open area of the housing of the motor adapter; and wherein there is provided a coupling disposed in the open area of the housing of the motor adapter that couples the output shaft of the motor to the input shaft of the drive shaft of the load adapter.

7. The dryer of claim 6 wherein the drive shaft of the load adapter is a one piece drive shaft rotatively mounted in a load adapter housing and wherein the one piece drive shaft projects from the load adapter housing into both the housing of the motor adapter and through the fan plug, and wherein the one piece drive shaft is operatively connected to the output shaft of the motor and to the fan.

8. The dryer of claim 1 wherein the fan plug includes a fabricated panel having a back and at least one rib disposed adjacent the back; and a load adapter mounting structure formed on the rib for interfacing with the load adapter.

9. The dryer of claim 8 wherein the fan plug includes a face panel spaced outwardly from the back of the fan plug so as to define an open space between the face panel and the back.

10. The dryer of claim 1 wherein the fan plug includes at least one cavity formed therein, and wherein the fan plug is provided with a pressure relief valve for venting the cavity.

11. The dryer of claim 1 wherein the motor adapter includes a housing having an open area and wherein the output shaft of the motor projects into the housing of the motor adapter; and wherein the drive shaft of the load adapter includes an input end that also projects into the housing of the motor adapter; and a coupling disposed in the housing of the motor adapter that interconnects the output shaft of the motor with the input end of the drive shaft of the load adapter.

12. The dryer of claim 11 wherein the drive shaft of the load adapter is a one piece drive shaft having an output end that projects through the fan plug and connects to a hub forming a part of the fan.

13. The dryer of claim 1 including at least a pair of bolts that project from the motor adapter through the load adapter and connects to a mounting structure forming a part of the fan plug.

14. A dryer for drying a product comprising:
a housing;
a drying chamber formed in the dryer;
a burner unit for heating air to dry the product;
a direct drive fan assembly for circulating air through the drying chamber; the direct drive fan assembly comprising:
(i) a fan plug secured to the dryer;
(ii) a fan mounted on an interior side of the fan plug;
(iii) a load adapter secured to the fan plug and projecting outwardly therefrom on the opposite side of the fan plug from the fan;
(iv) the load adapter having a housing;
(v) a motor adapter secured to the load adapter opposite the fan plug;
(vi) the motor adapter including a housing having an open area therein;
(vii) a motor mounted to the motor adapter opposite the load adapter, the motor having an output shaft; and
(viii) means extending through the housing of the motor adapter, through the housing of the load adapter and through the fan plug and operatively connected to the fan for transferring driving torque from the output shaft of the motor to the fan for rotatively driving the fan.

15. The dryer of claim 14 wherein said means comprises a continuous drive shaft assembly that is operatively connected between the output shaft of the motor and the fan and which extends through the motor adapter, through the load adapter, and through the fan plug.

16. The dryer of claim 15 wherein the fan plug supports the load adapter, which in turn supports the motor and motor adapter in cantilever fashion.

17. The dryer of claim 14 wherein the fan plug includes an interior open space and wherein the fan plug includes a pressure relief valve for venting the interior open space.

18. The dryer of claim 14 wherein the fan plug includes a fabricated panel having spaced apart exterior and interior sides and wherein there is provided at least one reinforcing structure disposed between the interior and exterior sides and wherein there is provided a load adapter connecting structure secured to the reinforcing structure that is operatively connected to the load adapter.

19. The dryer of claim 14 wherein said means includes a drive shaft rotatively mounted in the load adapter and wherein a portion of the drive shaft projects into the housing of the motor adapter; and wherein said means further includes a coupler disposed in the housing of the motor adapter for coupling the drive shaft with the output shaft of the motor.

20. The dryer of claim 19 wherein the drive shaft rotatively mounted in the load adapter includes another portion of the drive shaft that projects through the fan plug and is operatively connected to the fan for driving the same.
